(19) United States
(12) Patent Application Publication
(10) Pub. No.: US 2006/0049015 A1
(43) Pub. Date: Mar. 9, 2006

(54) Automatic nut running to torque without the possibility of slip

(75) Inventor: Kris Schuyten, Sint-Truiden (BE)

Correspondence Address: HARNESS, DICKEY & PIERCE, P.L.C., P.O. BOX 828, BLOOMFIELD HILLS, MI, 48303, US

(73) Assignee: Tenneco Automotive Operating Company, Inc., Lake Forest, IL (US)

(21) Appl. No.: 11/223,602

(22) Filed: Sep. 9, 2005

Related U.S. Application Data
(60) Provisional application No. 60/608,555, filed on Sep. 9, 2004.

(51) Int. Cl. F16F 9/36

(52) U.S. Cl. 188/322.17

(57) ABSTRACT

A shock absorber has a pressure tube, a piston slidably disposed in the pressure tube and a piston rod attached to the piston and extending out of the pressure tube. The end of the piston rod extending out of the pressure tube defines a contoured surface which can be engaged to prohibit rotation of the piston rod. In one embodiment the contoured surface is defined by an inner surface of a bore. In another embodiment, the contoured surface is defined by an exterior surface of an extension to the piston rod.

### FIELD OF THE INVENTION

The present invention relates to a McPherson strut assembly for a motor vehicle. More particularly, the present invention relates to a device which prohibits the slipping or rotating of the piston rod during the assembly of the McPherson strut assembly and the tightening of the retaining nut.

### BACKGROUND OF THE INVENTION

Strut-type suspension systems are well known in the motor vehicle industry. A telescopic strut normally incorporating a hydraulic damper including a piston rod is used as one of the locating members for the wheel of the motor vehicle. The most common form of a strut-type suspension system is the McPherson strut suspension system. The McPherson strut assembly includes a coil spring located concentrically around the telescopic strut or hydraulic damper. The upper end of the McPherson strut assembly includes an upper mount assembly which is secured to a tower formed by the vehicle body at a position above the wheel arch of the vehicle. The piston rod from the telescopic unit or shock absorber extends through the upper mount assembly and is secure in place using a retaining nut.

During the assembly of the McPherson strut assembly and the subsequent tightening of the retaining nut onto the end of the piston rod, there is the possibility that the piston rod will slip or rotate within the pressure tube of the shock absorber. This slipping or rotating of the piston rod creates difficulties in attaining the correct tightening torque for the retaining nut which maintains the assembly of the McPherson strut assembly.

### SUMMARY OF THE INVENTION

The present invention provides the art with a retention system which prohibits the rotation of the piston rod during the tightening of the retaining nut. The present invention provides a contoured surface such as a hexagon configuration on an outside surface of the end of the piston rod or a contoured surface such as a hexagon configuration on an inside surface of a bore extending into the end of the piston rod. A mating tool engages the contoured surface to prohibit rotation of the piston rod. The present invention can be used to manually prohibit rotation of the piston rod or the present invention can be incorporated into an automated assembly system to prohibit rotation of the piston rod during the automated assembly of the McPherson strut assembly.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an illustration of an automobile using the McPherson strut assembly in accordance with the present invention;

FIG. 2 is a side view of one of the front suspension units that incorporate the McPherson strut assembly in accordance with the present invention;

FIG. 3 is an enlarged view of the attachment of the piston rod to the upper mount assembly shown in FIG. 2;

FIG. 4 is an enlarged view of the end of the piston rod shown in FIG. 3; and

FIG. 5 is an enlarged view of the end of a piston rod in accordance with another embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

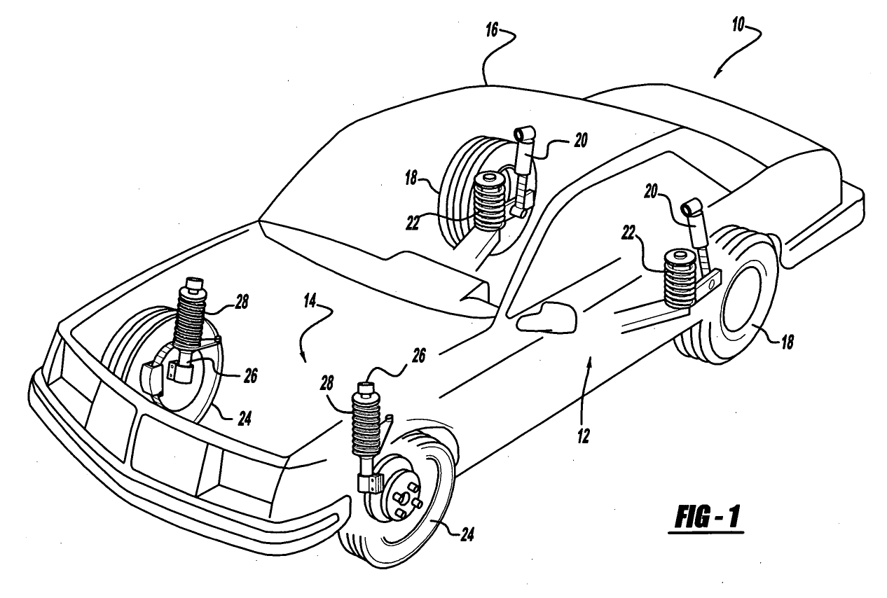

There is shown in FIG. 1 a vehicle incorporating a suspension system having the strut assembly in accordance with the present invention and which is designated generally by the reference numeral 10. Vehicle 10 comprises a rear suspension 12, a front suspension 14 and a body 16. Rear suspension 12 has a transversely extending rear axle assembly (not shown) adapted to operatively support the vehicle's rear wheels 18. The rear axle assembly is operatively connected to body 16 by means of a pair of shock absorbers 20 and a pair of helical coil springs 22. Similarly front suspension 14 includes a transversely extending front axle assembly (not shown) to operatively support the vehicle's front wheels 24. The front axle assembly is operatively connected to body 16 by means of a second pair of shock absorbers 26 and by a pair of shaped helical coil springs 28. Shock absorbers 20 and 26 serve to dampen the relative motion of the unsprung portion (i.e. front and rear suspensions 12 and 14, respectively) and the sprung portion (i.e. body 16) of vehicle 10. While vehicle 10 has been depicted as a passenger car having front and rear axle assemblies, shock absorbers 20 and 26 may be used with other types of vehicles and/or in other types of applications such as vehicles incorporating independent front and/or independent rear suspension systems. Further, the term “shock absorber” as used herein is meant to be dampers in general and thus will include McPherson struts. Also, while front suspension 14 is illustrated having a pair of McPherson struts or shock absorbers 26, it is within the scope of the present invention to have rear suspension 12 incorporate a pair of McPherson struts or shock absorbers 26 if desired.

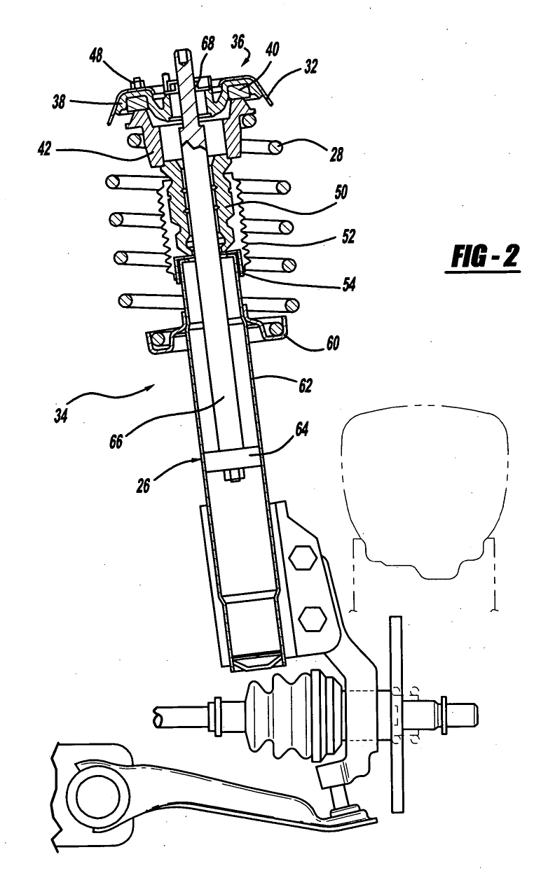

Referring now to FIG. 2, the front wheel assembly for vehicle 10 is illustrated in greater detail. Body 16 defines a shock tower 32 comprising sheet metal of vehicle 10 within which is mounted a McPherson strut assembly 34 which comprises a telescoping device in the form of shock absorber 26, coil spring 28 and a top mount assembly 36. McPherson strut assembly 34 including shock absorber 26, coil spring 28 and top mount assembly 36 are attached to vehicle 10 using shock tower 32. Top mount assembly 36 comprises a top mount 38, a bearing assembly 40 and an upper spring seat 42. Top mount 38 comprises an integral molded body and a rigid body member, typically made of stamped steel. Top mount assembly 36 is mounted to shock tower 32 by bolts 48 integrated into top mount 38 which extend through bolt holes formed in shock tower 32. Bearing assembly 40 is friction fit within the molded body of top mount 38 to be seated in top mount 38 so that one side of bearing assembly 40 is fixed relative to top mount 38 and shock tower 32. The second side of bearing assembly freely rotates with respect to the first side of bearing assembly 40, top mount 38 and shock tower 32.

The free rotating side of bearing assembly 40 carries upper spring seat 42 that is clearance fit to the outer diameter of bearing assembly 40. A jounce bumper 50 is disposed between upper spring seat 42 and shock absorber 26. Jounce bumper 50 comprises an elastomeric material which is protected by a plastic dirt shield 52. A bumper cap 54 is located on shock absorber 26 to interface with jounce bumper 50 and plastic dirt shield 52.

A lower spring seat 60 is attached to shock absorber 26 and coil spring 28 is disposed between upper spring seat 42 and lower spring seat 60 to isolate body 16 from front suspension 14. Shock absorber 26 comprises a pressure tube 62, a piston assembly 64 and a telescoping rod or piston rod 66. While shock absorber 26 is illustrated as a mono-tube design, it is within the scope of the present invention to utilize a dual-tube shock absorber for shock absorber 26. Also, while shock absorber 26 is illustrated in FIG. 2, it is to be understood that shock absorber 20 may also include the features described herein for shock absorber 26.

Prior to the assembly of McPherson strut assembly 34 into vehicle 10, the pre-assembly of McPherson strut assembly 34 is performed. Bumper cap 54, jounce bumper 50 and dirt shield 52 are assembled to shock absorber 26. Coil spring 28 is assembled over shock absorber 26 and positioned within lower spring seat 60. Upper spring seat 42 is assembled onto shock absorber 26 and correctly positioned with respect to coil spring 28. Bearing assembly 40 is positioned on top of upper spring seat 42 and top mount 38 is positioned on top of bearing assembly 40. This entire assembly is positioned within an assembly machine which compresses coil spring 28 such that the end of piston rod 66 extends through a bore located within top mount assembly 36. A retaining nut 68 is threadingly received on the end of piston rod 66 to secure the assembly of McPherson strut assembly 34.

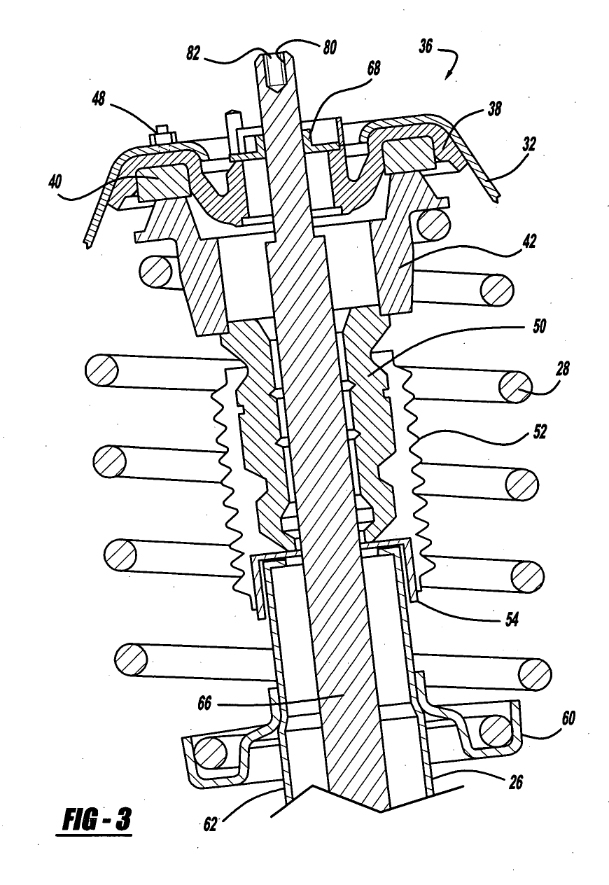

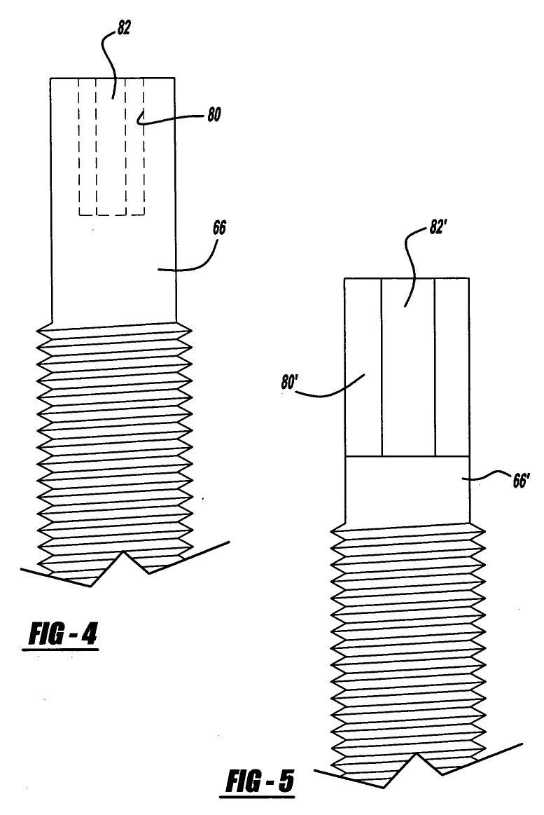

Referring now to FIGS. 3 and 4, the connection between piston rod 66 and top mount assembly 36 is illustrated in greater detail. When retaining nut 68 is assembled and tightened to secure piston rod 66, there is a tendency for piston rod 66 to rotate within pressure tube 62. This rotation of piston rod 66 causes problem with attaining the correct tightening torque for retaining nut 68. In order to eliminate this problem, the upper end of piston rod 66 is provided with a bore 80 defining a contoured surface 82. Contoured surface 82 is illustrated as a hexagon shape in FIGS. 3 and 4.

During assembly, retaining nut 68 is assembled over the top end of piston rod 66 and a nut driver begins the driving of retaining nut 68. The nut driving machine is designed to include a contoured probe, hexagon shape for piston rod 66, which extend through the driving component of the nut to prohibit the rotation of piston rod 66. The nut driver then takes retaining nut 68 up to its required torque and the nut driver and probe disengage from retaining nut 68 and piston rod 66 to complete the assembly.

Referring now to FIG. 5, a piston rod 66′ in accordance with another embodiment of the present invention is illustrated. Piston rod 66 defines bore 80 which defines a contoured surface 82. Piston rod 66′ defines an extension 80′ on the end of piston rod 66′ that defines an exterior contoured surface 82′. The probe in the nut driving machine for this design is designed to fit over extension 80′ to engage contoured surface 82′. Once retaining nut 68 reaches the proper torque, the nut driving machine disengages from retaining nut 68 and from extension 80′ on piston rod 66′.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A strut assembly comprising:
a telescoping device having a telescoping rod;
a first seat mounted to said telescoping device;
a second seat mounted to said telescoping device;
a spring mounted between said first seat and said second seat; wherein
an end of said telescoping rod defines a contoured surface such that engagement of said contoured surface with a stationary device prohibits rotation of said telescoping rod.

2. The strut assembly according to claim 1, wherein said end of said telescoping rod defines a bore extending into said telescoping rod, said contoured surface being defined by an inner surface of said bore.

3. The strut assembly according to claim 2, wherein said contoured surface is a hexagon shaped surface.

4. The strut assembly according to claim 1, wherein said end of said telescopic rod includes an extension, said contoured surface being defined by an outer surface of said extension.

5. The strut assembly according to claim 4, wherein said contoured surface is a hexagon shaped surface.

6. The strut assembly according to claim 1, wherein said end of said telescoping rod defines an external thread.

7. A shock absorber comprising:
a pressure tube;
a piston slidably disposed within said pressure tube;
a piston rod having a first end attached to said piston and a second end extending out one end of said pressure tube; wherein
said second end of said piston rod defines a contoured surface such that engagement of said contoured surface with a stationary device prohibits rotation of said piston rod.

8. The shock absorber according to claim 7, wherein said second end of said piston rod defines a bore extending into said piston rod, said contoured surface being defined by an inner surface of said bore.

9. The shock absorber according to claim 8, wherein said contoured surface is a hexagon shaped surface.

10. The shock absorber according to claim 7, wherein said second end of said piston rod includes an extension, said contoured surface being defined by an outer surface of said extension.

11. The shock absorber according to claim 10, wherein said contoured surface is a hexagon shaped surface.

12. The shock absorber according to claim 7, wherein said end of said piston rod defines an external thread.

13. A strut assembly comprising:
a shock absorber tube;
a piston axially movable with respect to said shock absorber tube;
a piston rod having a first end attached to said piston and a second end extending out one end of said shock absorber tube;
a first spring seat attached to said shock absorber tube;
a second spring seat attached to said piston rod;
a spring mounted between said first spring seat and said second spring seat; wherein
said second end of said piston rod defines a contoured surface such that engagement of said contoured surface with a stationary device prohibits rotation of said piston rod.

14. The strut assembly according to claim 13, wherein said second end of said piston rod defines a bore extending into said piston rod, said contoured surface being defined by an inner surface of said bore.

15. The strut assembly according to claim 14, wherein said contoured surface is a hexagon shaped surface.

16. The strut assembly according to claim 13, wherein said second end of said piston rod includes an extension, said contoured surface being defined by an outer surface of said extension.

17. The strut assembly according to claim 16, wherein said contoured surface is a hexagon shaped surface.

18. The strut assembly according to claim 13, wherein said end of said piston rod defines an external thread.
